(19) United States
(12) Patent Application Publication
(10) Pub. No.: US 2025/0148177 A1
(43) Pub. Date: May 8, 2025

(54) Circuit Design Support Device

(71) Applicant: Hitachi, Ltd., Tokyo (JP)

(72) Inventor: Takuma Nishimoto, Tokyo (JP)

(21) Appl. No.: 18/909,040

(22) Filed: Oct. 8, 2024

(30) Foreign Application Priority Data
Nov. 8, 2023 (JP) 2023-190884

(51) Int. Cl. G06F 30/30

(52) U.S. Cl. CPC G06F 30/30

(57) ABSTRACT

A circuit design support device includes: a control unit including a calculation device; a memory; a storage; an input device; and a display device. The storage stores overall circuit information, the input device inputs changed circuit information in the overall circuit information to the control unit including the calculation device, and the control unit including the calculation device calculates an influence on performance of the changed circuit information and on performance of another circuit in the overall circuit information, and calculates an influence on environment performance due to the changed circuit information, and displays, on the display device, the calculated influence on the performance of the circuit information and influence on the performance of the another circuit in the overall circuit information, and the influence on the environment performance due to the changed circuit information.

### BACKGROUND OF THE INVENTION

### 1. Field of the Invention

The present invention relates to a circuit design support device for supporting circuit design of a designer.

### 2. Description of Related Art

A circuit design support device for supporting circuit design of a designer is known in circuit design. As an example, PTL 1 discloses a circuit design support device and a circuit design support program that clearly indicate a function formed by a set of components constituting a circuit and facilitate understanding of a circuit diagram.

### CITATION LIST

### Patent Literature

PTL 1: JP2012-99007A

### SUMMARY OF THE INVENTION

According to the circuit design support device disclosed in PTL 1, a sufficient effect can be exhibited in designing a specific circuit. However, in an electric product in which the circuit is used, for example, even if one component is implemented by a certain circuit, there may be a circuit that has a large scale beyond that component and is implemented by combining the component and another component. In addition, in some cases, a circuit having a larger scale than a combination of a plurality of circuits having a large scale may be implemented. In an electric product including such a large-scale circuit, even if a certain circuit is optimized, for example, it may end up causing a negative result on the whole in relation to other circuits. Therefore, there is a need to establish and put into practical use a method for supporting circuit design with which a periphery is viewed rather than just focusing on individual circuits.

In recent years, consideration is also required for environment performance during the circuit design. For example, even if a design result improves circuit performance, degradation in the environment performance such as power consumption may not be tolerated. Therefore, the circuit design considering both the performance and the environment performance is required.

The invention has been made in light of the above circumstances, and provides a circuit design support device capable of evaluating and presenting an influence of a change on another circuit when designing or changing a circuit. Further, the invention provides a circuit design support device capable of presenting environment performance together with circuit performance, thereby enabling circuit design that achieves a good balance between circuit performance and environmental friendliness.

As an example of a method for solving the above problem, in a circuit design support device including a CPU; a memory; a storage; an input device; and a display device, the storage stores overall circuit information, an input unit inputs circuit information changed in the overall circuit information to the CPU, and the CPU calculates an influence on performance of the changed circuit information and on performance of another circuit in the overall circuit information, and calculates an influence on LCA performance (life cycle assessment performance) due to the changed circuit information, and displays, on the display unit, the calculated influence on the performance of the circuit information and influence on the performance of the another circuit in the overall circuit information, and the influence on the environment performance due to the changed circuit information.

Further methods and advantages of the invention will become apparent throughout the entire specification below.

The circuit design support device according to the invention enables a circuit designer to proceed with circuit design while checking, on a display unit, an influence on performance of the circuit due to a design change in the circuit, an influence on the performance of another circuit, and an influence on environment performance. Therefore, the circuit design that achieves both the performance and the environment performance can be efficiently advanced.

Further methods and advantages of the invention will become apparent throughout the entire specification below.

### BRIEF DESCRIPTION OF THE DRAWINGS

FIG. 1 is a diagram showing a configuration example of a circuit design support device according to an embodiment of the invention;

FIG. 2 is a diagram showing a configuration example of the circuit design support device according to an embodiment of the invention;

FIG. 3 is a diagram showing an example of a processing concept of the circuit design support device according to the invention;

FIG. 4 is a diagram showing a graph topology according to an embodiment of the invention;

FIG. 5A is a diagram showing an example of a target substrate according to an embodiment of the invention;

FIG. 5B is a diagram showing an example of nodes according to an embodiment of the invention;

FIG. 5C is a diagram showing an example of a data structure according to an embodiment of the invention;

FIG. 6A is a diagram showing an example of a target unit according to an embodiment of the invention;

FIG. 6B is a diagram showing an example of the target unit according to an embodiment of the invention;

FIG. 6C is a diagram showing an example of a simultaneous display of the nodes and the data structure according to an embodiment of the invention;

FIG. 6D is a diagram showing an example of nodes according to an embodiment of the invention;

FIG. 6E is a diagram showing an example of a data structure according to an embodiment of the invention;

FIG. 7A is a diagram showing an example of a target device according to an embodiment of the invention;

FIG. 7B is a diagram showing an example of a target device according to an embodiment of the invention;

FIG. 7C is a diagram showing an example of a simultaneous display of the nodes and the data structure according to an embodiment of the invention;

FIG. 7D is a diagram showing an example of nodes according to an embodiment of the invention;

FIG. 7E is a diagram showing an example of a data structure according to an embodiment of the invention;

FIG. 8A is a diagram showing an example of a display screen of the circuit design support device according to an embodiment of the invention;

FIG. 8B is a diagram showing an example of the display screen of the circuit design support device according to an embodiment of the invention;

FIG. 9 is a flowchart of an embodiment of the invention; and

FIG. 10 is a flowchart of an embodiment of the invention.

### DESCRIPTION OF EMBODIMENTS

Hereinafter, embodiments of the invention will be described with reference to the drawings.

### Embodiment 1

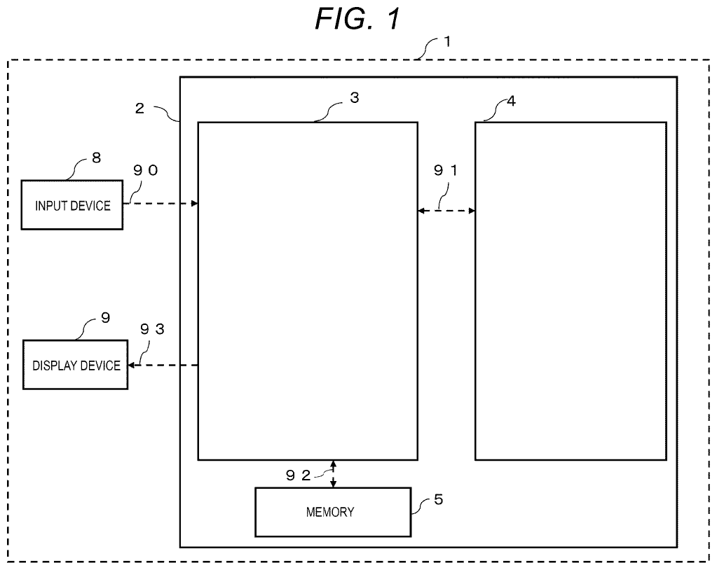

FIG. 1 is a diagram showing a configuration example of a circuit design support device according to the present embodiment. Reference numeral 1 denotes the entire circuit design support device, and reference numeral 2 denotes a control unit. Examples include a main body of a server, a PC, or a workstation. Reference numeral 8 denotes an input device, and reference numeral 9 denotes a display device. The control unit 2 includes a CPU 3 that performs calculation processing, a storage 4, and a memory 5 that cooperates with the CPU 3 and the storage 4.

Based on circuit design change information 90 input from the input device 8, the CPU calculates circuit performance and environment performance for the design change information. At this time, data exchange 91 is performed between the calculation device, for example, between the CPU 3 and the storage 4 in two directions, and reference to a database stored in the storage 4 or information writing into the database on the storage 4 is performed. Similarly, data exchange 92 in both directions between the CPU 3 and a memory 5 is performed.

The environment performance at this time may be LCA performance. In addition, it may be part of the environment performance such as power consumption. Alternatively, processing same as the processing described in the specification of the application will not be excluded from the scope of the present application by focusing on other evaluation items other than the environment performance.

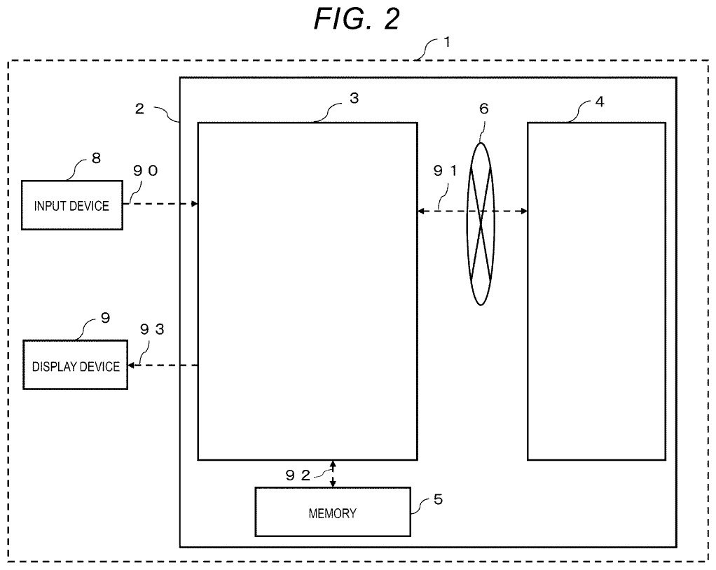

FIG. 2 is a case in which a communication network 6 is interposed between the CPU 3 and the storage 4 in FIG. 1. The diagram shows that, with the development of cloud environment in recent years, the control unit 2 or the circuit design support device 1 can be implemented even when such a CPU and storage are located in spatially distant locations. The circuit design support device 1 according to the present application includes a case in which the circuit design is distributed in terms of hardware as shown in FIG. 2. Therefore, terms and concept of the circuit design support device 1 according to the present application also include a circuit design support system.

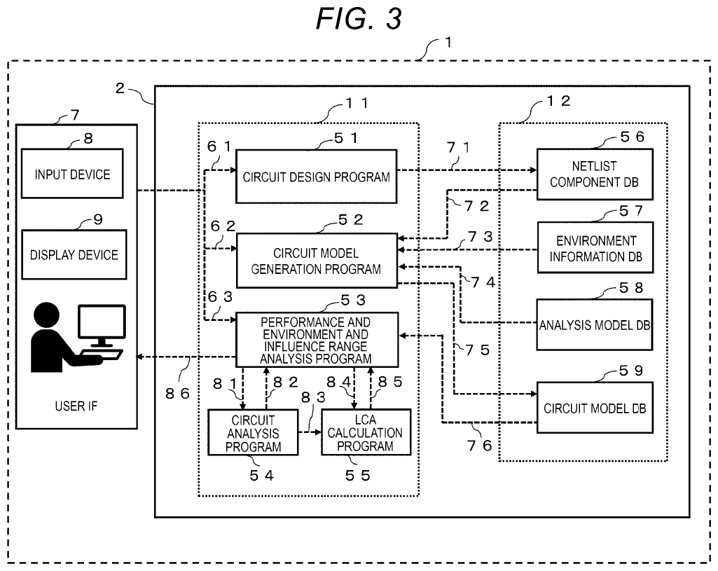

FIG. 3 is a diagram showing the circuit design support device 1 according to the present application, focusing particularly on a flow of data processing, calculation processing, or circuit design support.

In FIG. 3, a user IF (interface) 7 having both the input device 8 and the display device 9 of FIG. 1 is provided.

In FIG. 3, reference numeral 11 denotes a portion focusing on program processing performed by the CPU 3 in the control unit 2. Similarly, reference numeral 12 in FIG. 3 denotes a portion indicating various DBs (databases) stored in the storage 4.

The processing program executed by the CPU 3 includes a circuit design program 51, a circuit model generation program 52, a performance and environment and influence range analysis program 53, a circuit analysis program 54, an LCA calculation program 55, and the like.

The DBs (database) on the storage 4 include a netlist and component DB 56, an environment information DB 57, an analysis model DB 58, and a circuit model DB 59.

First, a user or a designer inputs design information 61 together with a circuit design instruction to the circuit design program 51 via the user IF 7. At this time, the circuit design includes a case in which a part of an existing circuit is changed. The circuit design program 51 is not limited to be an original program, and an existing circuit design tool may be used. Alternatively, the circuit design program portion may be performed in cooperation with an external PC, a server, a workstation, or the like.

The circuit design program 51 generates a netlist and a component list based on a circuit diagram input by the user. The generated information is transmitted from the CPU 3 to the storage 4 via a component denoted by 71 and stored in the netlist and component DB 56 on the storage 4.

Next, an operation of the circuit model generation program 52 will be described. The circuit model generation program 52 relates to a designated or all circuits mounted on a target product, and acquires the netlist and the component list from the netlist and component DB 56 via a component denoted by 72. Similarly, environment information is acquired from the environment information DB 57 via a component denoted by 73. Similarly, an analysis model is acquired from the analysis model DB 58 via a component denoted by 74. In addition, a target product designation and input and output information are received from the user or the designer via the user IF 7.

The circuit model generation program 52 generates a circuit model data structure based on the data or information. The generated circuit model data structure is stored in the circuit model DB 59 via a component denoted by 75.

The performance and environment and influence range analysis program 53 receives a designation of a target portion and an analysis item from the user IF 7, and receives design information or re-design information from the user or the designer. Further, a netlist of a target circuit is generated based on a circuit model stored in the circuit model DB 59.

Thereafter, the performance and environment and influence range analysis program 53 transmits, as information denoted by 81, information on the netlist, the analysis model, and a designation performance item to the circuit analysis program 54. In addition, the performance and environment and influence range analysis program 53 transmits, as information denoted by 84, a list of the environment information and a designation of an LCA item to the LCA calculation program 55.

The circuit analysis program 54 outputs an analysis result obtained by analyzing the input netlist and the circuit performance designated from the analysis model to the performance and environment and influence range analysis program 53 and via a component denoted by 82. Information 83 related to power in the circuit in the analysis is transferred to the LCA calculation program 55.

The LCA calculation program 55 calculates the designated LCA item based on the input environment information and a result of the power analysis of the circuit analysis program 54, and outputs the result to the performance and environment and influence range analysis program 53 as information denoted by 85.

The performance and environment and influence range analysis program 53 generates the netlist of the target circuit based on the circuit model based on the item designated by the user. In addition, the environment information of the component used in the target circuit is extracted, and the result of the designated item, an influence range, and changed characteristic information are output based on the results of the circuit analysis program 54 and the LCA calculation program 55. The information is output to the user IF as information denoted by 86, and presented to the user or the designer through the display device 9.

The netlist and component DB 56 stores a netlist and a list of components for some or all of the designed circuits. The environment information DB 57 stores environment information of components and materials of a development product. The analysis model DB 58 stores an analysis model of circuit components of a development product. The circuit model DB 59 stores a circuit model data structure including circuit network information of the entire product and environment information.

Such a circuit design support device 1 can reduce a burden on the designer in the circuit design, and can speed up and improve accuracy of design work. In particular, when in consideration of the LCA performance, improvement design is performed while checking a performance analysis result and an LCA calculation result, making it possible to improve the LCA for the entire product, thereby achieving a higher level of compatibility between product performance and reduced environmental impact.

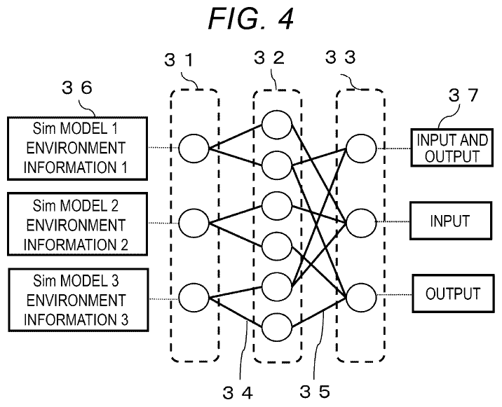

FIG. 4 is a diagram showing a graph topology structure, which is another central feature of the circuit design support device according to the invention.

In the related art, two graphs are known as a graph topology structure used for circuit analysis. One is a graph topology structure for circuit network analysis, and the other is a graph topology structure for automatic layout.

The former is a graph topology structure that focuses on wiring, represents each wiring as a node with a circle, connects the circles with connection lines that act as edges, and represents each connection line by assigning actual components such as a resistor, a power supply, a capacitor, and coils thereto. This is a graph topology structure mainly used for a collection of two-terminal components, and is a graph topology structure intended for analysis of a circuit network according to a determinant. The latter is a graph topology structure aimed at automatic layout in which actual components, that is, parts, are represented as nodes with circles and listed on a left side, and wirings are represented as nodes with circles and listed on a right side, with these connected in accordance with circuits using connection lines that act as edges, and terminal information is assigned to the connection lines.

For these graph topology structures known in the related art, the invention has a major feature in that it devises and employs a new graph topology structure. Accordingly, it is possible to efficiently perform circuit analysis and performance evaluation, especially in the case of analysis of large-scale circuits spanning multiple layers, and will contribute greatly to a significant reduction in a scale of calculation and an increase in speed, especially in the circuit design support device.

The graph topology structure used in the invention will be described with reference to FIG. 4. As shown in reference numeral 31 on the left side of FIG. 4, nodes assigned to respective components are provided as the part nodes 31. As shown in reference numeral 33 on the right side of FIG. 4, nodes assigned to respective wirings are provided as the wiring nodes 33. In the graph topology structure according to the invention, nodes assigned to each terminal in advance as terminal nodes 32 are used between the part nodes 31 and the wiring nodes 33.

Accordingly, in the circuit design of large-scale circuit groups, it is possible to smoothly cooperate and pass on circuit information in a lower layer to a middle layer above it and then to an upper layer above the middle layer. Therefore, in the circuit design support device, it is considered that the circuit network of the entire device is represented by a graph topology structure used in the invention, and that the circuit network itself is used for analysis and is novel and inventive.

In each node of the part node 31, that is, a part, information on a Sim model (simulation model) and environment information are associated with part information 36.

Each node of the wiring nodes 33, that is, each wiring, is associated with information on a type of the wiring as wiring information 37. Examples thereof include input and output, input, and output.

A relationship between the part node 31 and the terminal node 32, that is, a relationship between each part and each terminal is represented by connection lines as part and terminal edges 34. A relationship between the terminal node 32 and the wiring node 33, that is, a relationship between each terminal and each wiring is represented by connection lines as terminal and wiring edges 35.

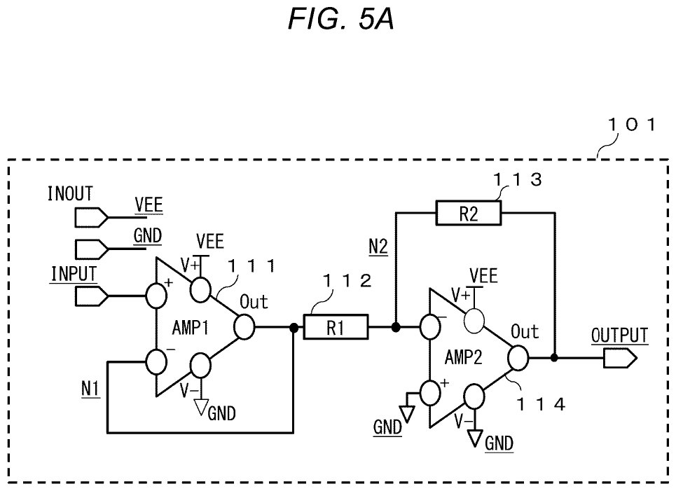

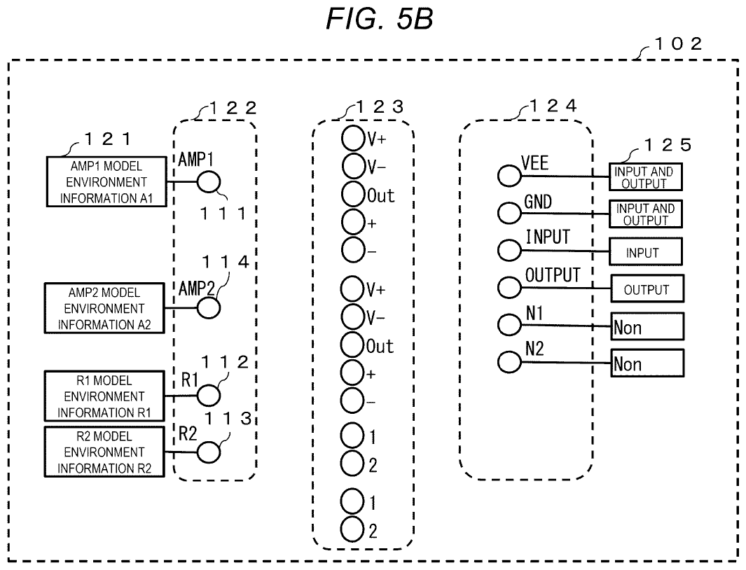

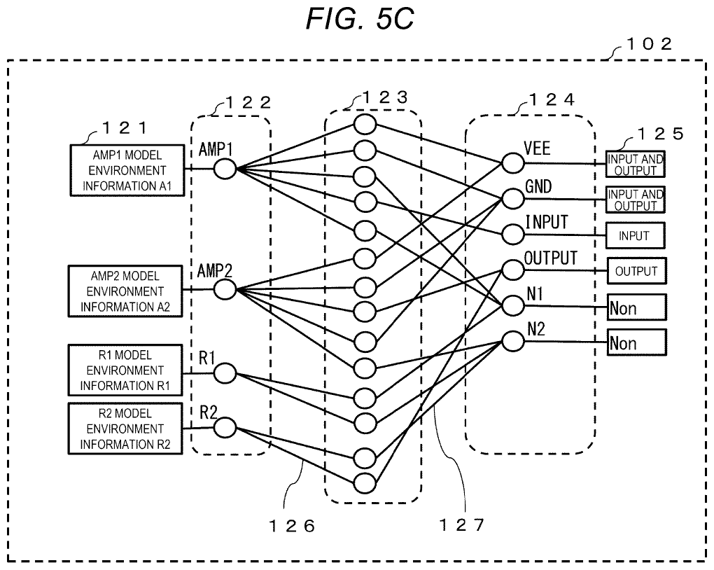

Examples of a concept or a way of use in FIG. 4 will be described in more detail with reference to FIGS. 5A to 5C. FIGS. 5A to 5C are diagrams showing circuit diagrams and graph topology structures of a portion of the device, and here, referred to as a substrate A. FIG. 5A is a circuit diagram. FIG. 5C is a diagram in which the circuit diagram of FIG. 5A is represented in the graph topology structure. FIG. 5B is a diagram in which the connection lines between the nodes are erased so that sites of the terminal nodes in the graph topology structure of FIG. 5C can be checked.

First, FIG. 5A will be described. FIG. 5A is a circuit model related to, for example, the substrate A. Reference numeral 101 denotes an overall circuit diagram of the substrate A, and is an example of a circuit including AMP1 as an amplifier 111, R1 as a resistor 112, R2 as a resistor 113, and AMP2 as an amplifier 114.

The circuit itself is merely a circuit used for description in the invention, and no invention is claimed in relation to the circuit itself.

FIG. 5B is a diagram in which the circuit of FIG. 5A is represented by a graph topology structure similar to that of FIG. 4. In FIG. 5B, the connection lines between the nodes are not shown. This is for the purpose of description, and the connection lines are described with reference to FIG. 5C.

First, a description will be given with reference to FIG. 5B. Nodes corresponding to each of the parts of AMP1, AMP2, R1, and R2 in FIG. 5A are set in a part node 122 on the left side of FIG. 5B. Reference numeral 111 corresponds to the AMP1, reference numeral 114 corresponds to the AMP2, 113 corresponds to the R1, and reference numeral 112 corresponds to the R2.

Each part in the part node is associated with the circuit model and the environment information of each part as 121.

Nodes corresponding to each of the wirings in FIG. 5A are set in a wiring node 124 on the right side of FIG. 5B. Wiring information 125 is associated with each node in the wiring node 124. The wiring information 125 includes input and output, input, output, and Non.

The wiring node 124 is basically set in accordance with actual input and output. In FIG. 5B, top four nodes among the wiring nodes 124 are directly involved in input and output. Therefore, the nodes refer to the wirings and at the same time the input and the output. Meanwhile, the lower two, N1 and N2, are nodes set for the wiring itself. Therefore, since the information is not associated with the information on direct input and output to and from the outside, the information is associated as Non in the wiring information 125. In this way, by setting the wiring node as necessary in the wiring itself that is not associated with the outside, the entire circuit can be appropriately described in the graph topology structure according to the invention.

Terminal nodes 123 that can achieve a better effect by being used in the present application are set between the part nodes 122 and the wiring nodes 124. This is set corresponding to a terminal in an actual circuit.

Next, a description will be given with reference to FIG. 5C. Reference numeral 102 denotes the entire substrate A shown in a graph topology structure. In FIG. 5C, functions and assignment of the terminals in the terminal nodes 123, for example, descriptions of V+, V−, Out, 1, 2, and the like are omitted. This is for the purpose of description, making the drawing easier to read by simplifying the lines, and in practice, it is desirable to simultaneously display these descriptions and connection line information of FIG. 5C.

A relationship between the part nodes 122 and the terminal nodes 123, that is, a relationship between each part and each terminal is represented by connection lines as part and terminal edges 126. A relationship between the terminal nodes 123 and the wiring nodes 124, that is, a relationship between each terminal and each wiring is represented by a connection line as terminal and wiring edges 127.

As described above, the representation using the graph topology structure enables circuit modeling with higher accuracy, and is particularly suitable for representation of a large-scale circuit or for large-scale calculation.

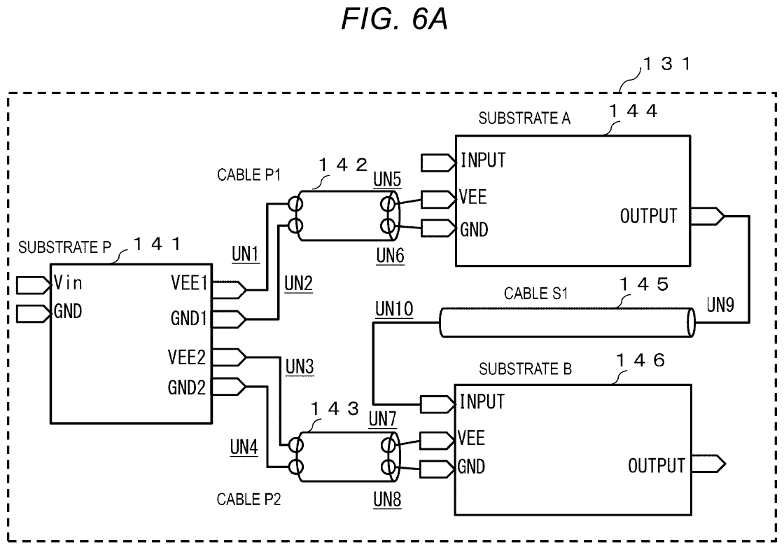

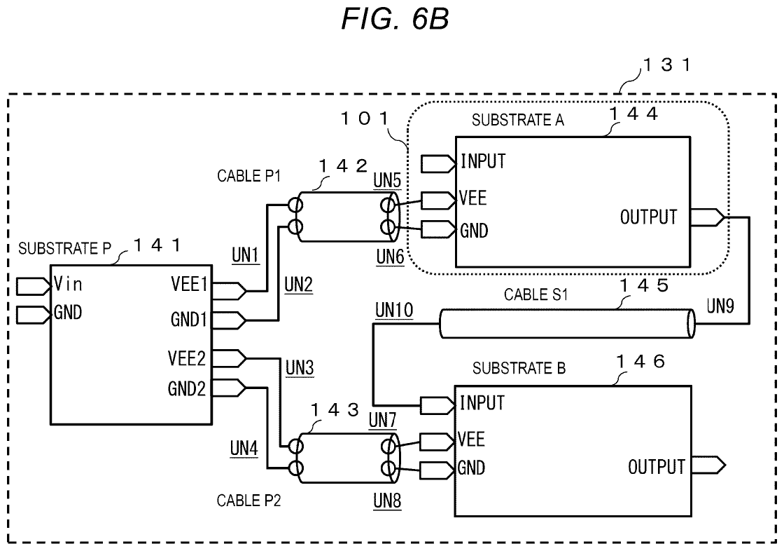

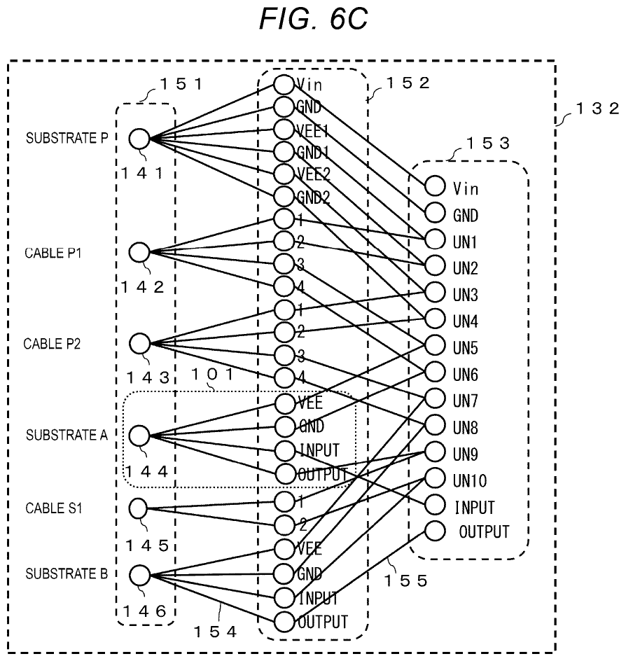

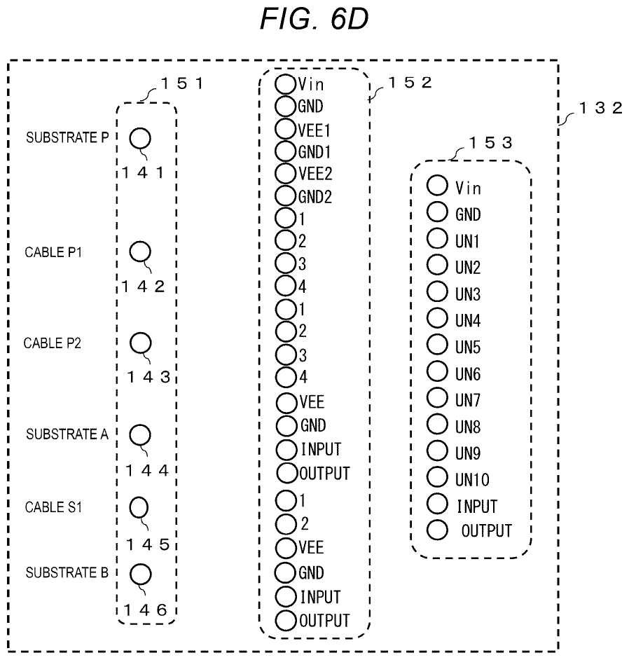

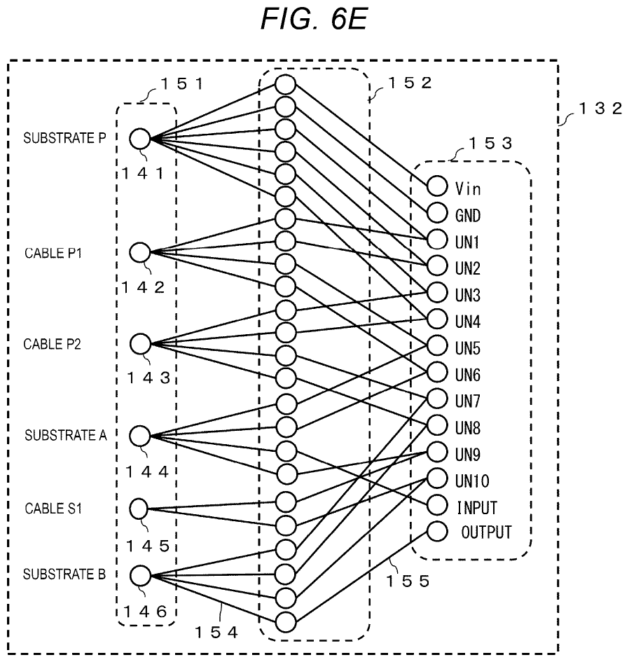

As described above, the graph topology structure is particularly suitable for the representation of the large-scale circuit or the large-scale calculation, which is to be described with reference to FIGS. 6A to 6E.

FIG. 6A is a circuit model related to, for example, a unit A. When the substrate A in FIG. 5A is a lower layer, the unit A in FIG. 6A can be said to be a middle layer including a part of the substrate A. Reference numeral 131 denotes an overall circuit diagram of the unit A, reference numeral 141 denotes a substrate P, reference numeral 142 denotes a cable P1, reference numeral 143 denotes a cable P2, reference numeral 144 denotes the substrate A, reference numeral 145 denotes a cable S1, and reference numeral 146 denotes a substrate B. Although the drawings are described as the substrate A, the substrate B, and the substrate P, the same applies if they are a circuit group A, a circuit group B, and a circuit group P. The substrate A in FIG. 6A is a portion corresponding to reference numeral 101 in FIG. 5A, as indicated by reference numeral 101 in FIG. 6B.

FIG. 6C is a diagram in which the circuit of FIG. 6A is represented by a graph topology structure. This is also an example of a display screen.

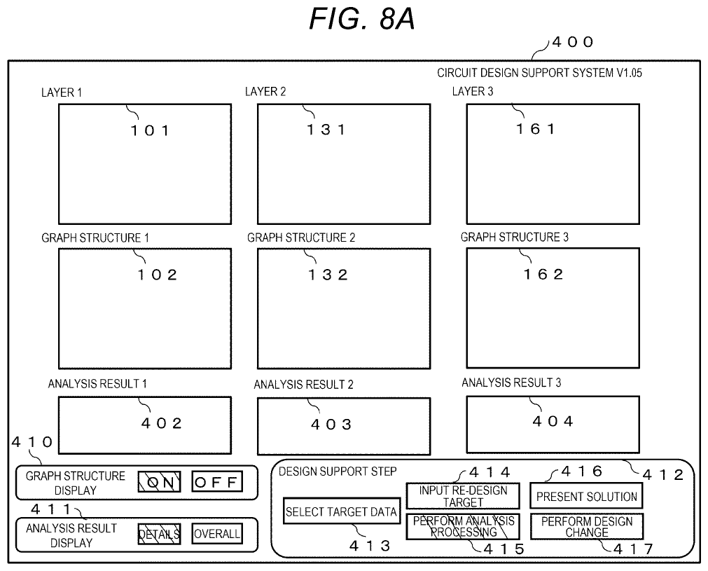

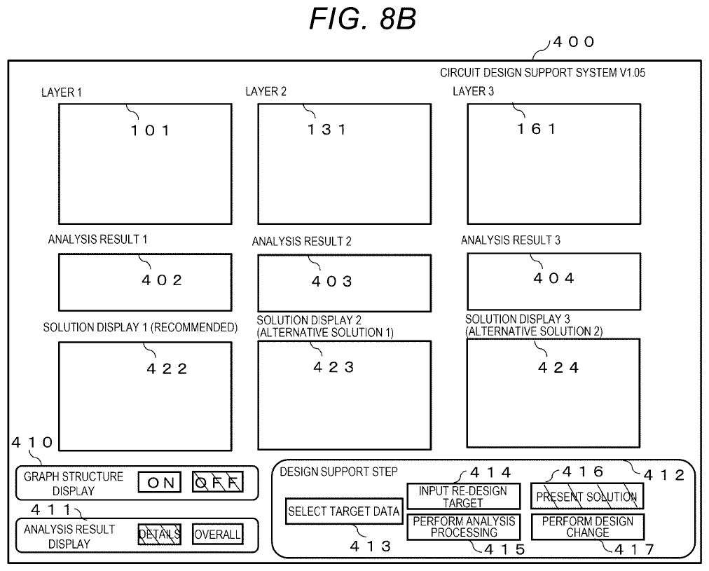

FIG. 6C is a representation of FIG. 5B+FIG. 5C, and the functions and the assignment of the terminals in the terminal nodes and both the part and terminal edges and the terminal and wiring edges are simultaneously displayed. An example of a screen display of the circuit design support device according to the invention will be described later with reference to FIG. 8A. At that time, it is desirable for the graph topology structure displayed and presented to the designer to include a large amount of pieces of information, as shown in FIG. 6C. This is because color display is possible in the display device 9, and the types of information can be divided by color coding. For example, node information is black, assignment information is green, and edge information is blue.

Reference numeral 132 denotes the entire unit A shown in a graph topology structure. In a part node 151, the nodes are set as follows: reference numeral 141 corresponding to the substrate P, reference numeral 141 corresponding to the cable P1, reference numeral 143 corresponding to the cable P2, reference numeral 144 corresponding to the substrate A, reference numeral 145 corresponding to the cable S1, and reference numeral 146 corresponding to the substrate B. As shown in FIG. 6C, a large number of input and output and wirings are set as nodes in a wiring node 153. In a terminal node 152, similarly to the case for the substrate A, settings are made corresponding to the actual terminals and input and output. Part and terminal edges 154 display a connection relationship between the parts and the terminals, and terminal and wiring edges 155 display a connection relationship between the terminals and the wirings.

As shown in FIG. 6C, in the graph topology display of the unit A, the substrate A in FIG. 5A can be taken as the reference numeral 101 and taken in as a part of a configuration requirement. As well as in the substrate P, the substrate B, or other elements, information on the lower layer can be similarly formed seamlessly. This is a major strength of the invention, which uses a graph topology structure to represent and analyze circuits. By consolidating and analyzing the lower layer, and then continuing to consolidate and analyze the result into the upper layer, it is possible to seamlessly analyze a large-scale circuit or a complex design item.

FIG. 6D is a diagram showing only the nodes by deleting the lines of the part and terminal edges 154 and the terminal and wiring edges 155 from FIG. 6C.

FIG. 6E is a diagram showing a connection relationship between the part and terminal edges 154 and the terminal and wiring edges 155 extracted by deleting the assignment details of the terminal nodes from FIG. 6C.

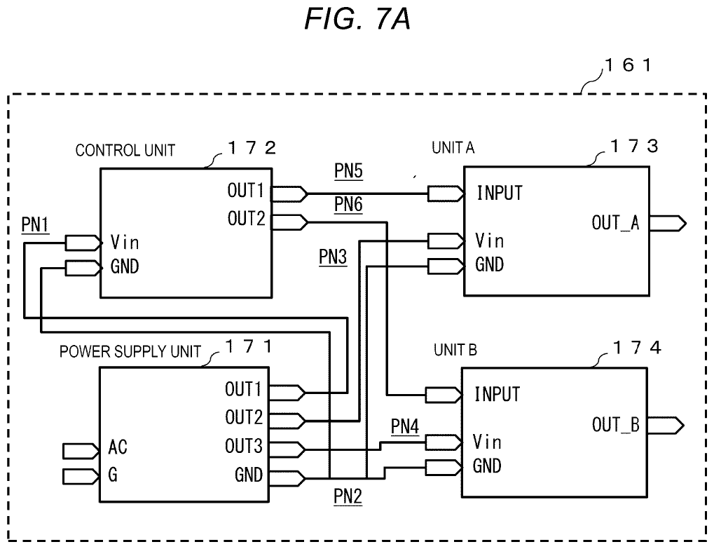

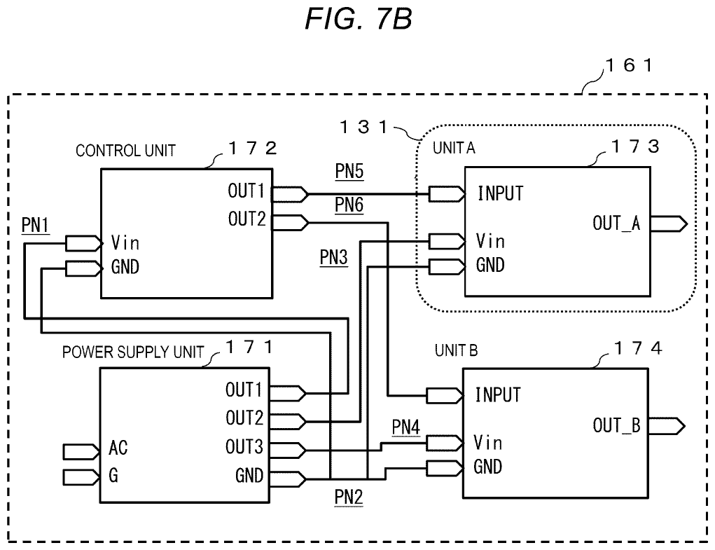

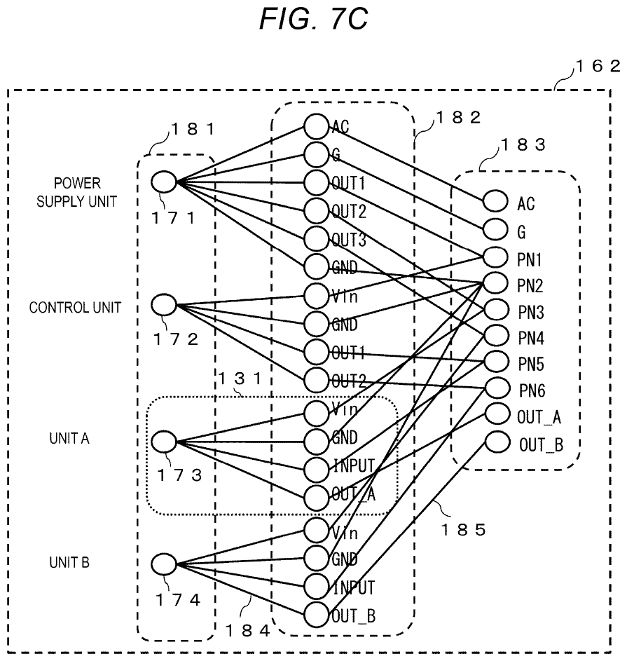

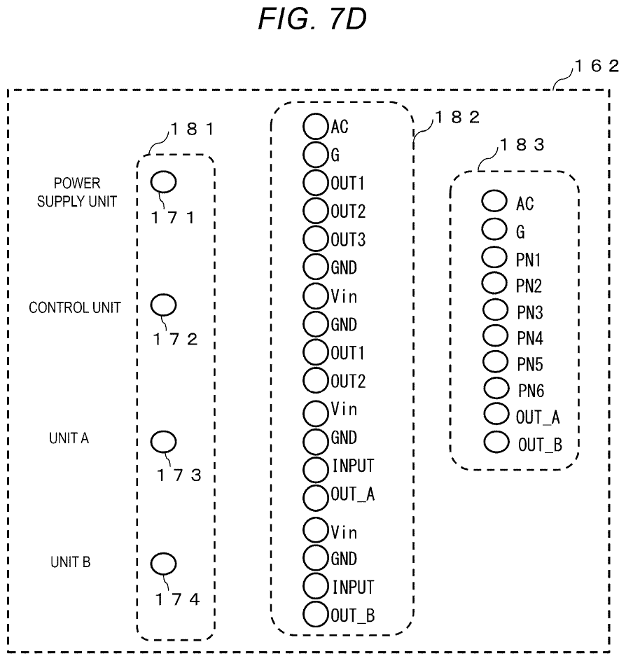

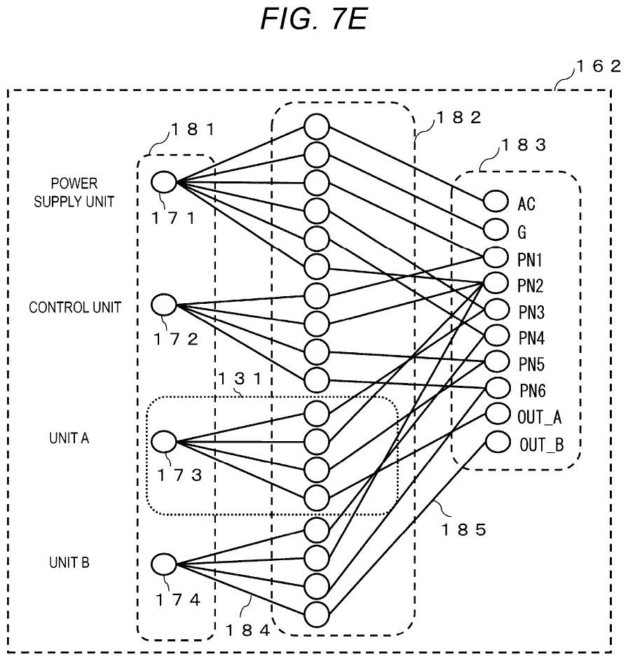

Next, a case in which the analysis proceeds to the upper layer will be described with reference to FIG. 7A. FIG. 7A is an uppermost layer, which is a circuit diagram of the entire circuit or the entire product to be designed. Here, it is assumed to be a product. Reference numeral 161 is a circuit diagram of the entire product, reference numeral 171 is a power supply unit, reference numeral 172 is a control unit, reference numeral 173 is the unit A, and reference numeral 174 is the unit B.

As shown with the reference numeral 131 in FIG. 7B, the unit A in FIG. 6A is taken as a part of the lower layer constituting the reference numeral 161 as the reference numeral 173 in FIG. 7A.

FIG. 7C is a diagram in which the circuit of FIG. 7A is represented by a graph topology structure. Although the layers are different, this corresponds to the representation in FIG. 6C. This is also an example of the display screen.

Reference numeral 162 denotes the entire product shown in a graph topology structure. In a part node 181, the nodes are set as follows: reference numeral 181 corresponding to the power supply unit, reference numeral 172 corresponding to the control unit, reference numeral 173 corresponding to the unit A, and reference numeral 174 corresponding to the unit B. As shown in FIG. 7C, a large number of input and output and wirings are set as nodes in a wiring node 183. In a terminal node 182, similarly to the case for the substrate A, settings are made corresponding to the actual terminals and input and output. Part and terminal edges 184 display a connection relationship between the parts and the terminals, and terminal and wiring edges 185 display a connection relationship between the terminals and the wirings.

As shown in FIG. 7C, in the display of the graph topology structure 162 of the entire product, the unit A in FIG. 6A can be taken as the reference numeral 131 and taken in as a part of a configuration requirement. Similarly, in the power supply unit, the control unit, or other constituent units, information on the lower layer can be similarly formed seamlessly. This is a major strength of the invention, which uses a graph topology structure to represent and analyze circuits. By consolidating and analyzing the lower layer, and then continuing to consolidate and analyze the result into the upper layer, it is possible to seamlessly analyze a large-scale circuit or a complex design item.

FIG. 7D is a diagram showing only the nodes by deleting the lines of the part and terminal edges 184 and the terminal and wiring edges 185 from FIG. 7C.

FIG. 7E is a diagram showing a connection relationship between the part and terminal edges 184 and the terminal and wiring edges 185 extracted by deleting the assignment details of the terminal nodes from FIG. 7C.

As described above in detail with reference to FIGS. 5 to 7, by representing a circuit using a graph topology structure and performing circuit analysis using the same, it is possible to seamlessly analyze overall design and performance based on a lower circuit to an upper circuit and the product particularly in the large-scale circuit. Accordingly, it is possible to seamlessly and efficiently analyze the influence that a design change or a performance change in the lower circuit or a part thereof has on performance or characteristics in members, circuits, or the upper layers in the vicinity thereof, or in the entire product.

In the circuit design support device using the graph topology structure according to the present application, seamless and efficient design and analysis can be achieved over the entire product, thereby improving the efficiency of circuit design and reducing a time required for design. In addition, since a larger number of items can be set as an evaluation item compared with the related art, when the invention is applied to a circuit design support device that performs the LCA calculation as shown in FIG. 3, efficient performance evaluation and environment evaluation can be achieved in a short time. Further, since it is possible to evaluate the influence in terms of performance and the influence in terms of environment on other members or the entire product due to changes in a part of the circuits and members, it is possible to provide a circuit design support device effective in circuit design corresponding to environmental issues.

### Embodiment 2

The present embodiment is an example of a display screen on the display device 9 in the circuit design support device 1 that performs the circuit analysis using the graph topology structure in Embodiment 1.

FIG. 8A shows an example of the display screen in the circuit design support device 1. Reference numeral 400 denotes a display screen, the reference numeral 101 denotes a display area for the circuit 101 of the substrate A in FIG. 5A, the reference numeral 131 denotes a display area for the circuit 131 of the unit A in FIG. 6A, and the reference numeral 161 denotes a display area for the circuit 161 of the product in FIG. 7A. A layer 1, a layer 2, and a layer 3 are displayed in this order from the left, and from the lower to the upper. Accordingly, it is possible for the designer to easily check the screen where a portion to be subjected to the design change corresponds within the overall product circuit.

The reference numeral 102 denotes a display area of the graph topology of the substrate A according to FIGS. 5B and 5C or the superimposed display thereof, and is a display related to the layer 1 corresponding to the circuit of the substrate A indicated in 101. The reference numeral 132 denotes a display area of the graph topology of the unit A in FIG. 6C and the like, and is a display related to the layer 2 corresponding to the circuit of the unit A indicated in 131. The reference numeral 162 denotes a display area of the graph topology of the product in FIG. 7C and the like, and is a display related to the layer 3 corresponding to the circuit of the product indicated in 161.

In this way, by displaying the circuit screen and the graph topology display corresponding to the circuit side-by-side on the display screen 400, the designer can easily verify and check the graph topology information set for the circuit. Therefore, it is possible to grasp a model construction error at the most early stage and correct the model construction error as necessary. Accordingly, it is possible to prevent performance and characteristics in an actual circuit and a deviation of performance and characteristics in calculation from occurring due to the model construction error.

Reference numeral 402 denotes a display column of an analysis result for the circuit of the layer 1, reference numeral 403 denotes a display column of an analysis result for the circuit of the layer 2, and reference numeral 404 denotes a display column of an analysis result for the circuit of the layer 3. A content to be displayed can be set in advance by the designer in the circuit design support device 1. In addition to the performance and the power consumption, for example, in the circuit design support device 1 that also calculates the LCA performance as shown in FIG. 3, an analysis result of the LCA performance may be displayed together with the area.

The display allows the performance, the power consumption, and the LCA performance to be checked side-by-side across layers, making it easy to check the influence of a design change on other locations or the whole system, as well as bottlenecks in the design.

The graph topology structures indicated in 102, 132, and 162 include a case in which the display on the screen is not assumed. This is because, in a case in which the circuit design support device 1 is sufficiently reliable or in a case in which there is no concern that the graph topology structure may be influenced only by changing the fixed design, the check by the designer can be omitted. Therefore, in the circuit design support device 1 according to the present embodiment, ON and OFF of the graph topology structure display can be switched with 410. This is achieved by selecting a desired item through the user IF by the designer operating a mouse or clicking on the screen.

Reference number 411 is a setting item for switching display accuracy of the analysis result. A detailed display and an overall display can be switched. FIG. 8A shows an example in which the detailed display is selected in a detailed tab. However, in cases where it is clear that there will be almost no influence on lower layers, or when only the analysis results and influence on the final product as a whole are desired to be known, an overall tab may be used to display only an overall analysis result and evaluation result by integrating the display areas 401, 402, and 403.

Reference numeral 412 is a tab area for selecting a design support STEP. A target data selection tab 413 switches to a screen for inputting information on the circuit to be changed and the contents of the change, or, in the case of a newly designed circuit, to that information input screen. Reference numeral 414 is a tab for inputting a target to be re-designed. An existing circuit library is called, and a part thereof is designated on the screen, and change information corresponding thereto is input. Reference numeral 415 is a tab for performing analysis processing after the designer completes the input of data. By clicking the tab, the circuit design support device 1 performs performance analysis and characteristic analysis of the circuit, and displays the result on the display screen 400. An example is the display areas 402, 403, and 404 in which the analysis results are shown in FIG. 8A. Reference numeral 416 is a tab for presenting a solution. By clicking the tab, the circuit design support device considers a solution to an undelivered matter or the like in bottlenecks in performance or environmental characteristics, and displays the solution on the screen. Reference numeral 417 is a tab for performing design change. When it is determined that predetermined performance is satisfied based on the analysis in the circuit design support device 1, the designer clicks the tab, so that a design condition on the circuit design support device becomes a determination condition and is reflected in a design database or the like.

FIG. 8B shows an example in which the graph topology structure display of 410 is turned OFF and the tab 416 for presenting solution is clicked, with respect to the display screen of FIG. 8A.

In this example, the graph topology structures 102, 132, and 162 are removed, and instead, the display areas for the analysis results 402, 403, and 404 are shifted to the upper side, with solutions being displayed below the display areas. Each of reference numerals 422, 423, and 424 is a display of a solution. When there are a plurality of solutions, the reference numeral 422 indicates a first-priority recommended solution, the reference numeral 423 indicates a first example of an alternative solution 1, and the reference numeral 424 indicates a second example of the alternative solution. As described above, by allowing the circuit design support device to present and display a plurality of solutions, the designer can determine and adopt a most optimal solution.

In the solution presentation, the circuit design support device may be considered and presented. Alternatively, consideration and presentation may be made in conjunction with an external program or a processing device. In recent years, with the rapid improvement in speed and determination capability of AI and deep learning through machine learning, it may not be optimal to complete everything within a single device.

In the invention, all the circuit design support device capable of displaying circuit information in a graph topology structure or a circuit design support device capable of displaying a graph topology structure on a screen are included in the scope of the invention. A circuit design support device capable of displaying a graph topology structure on a screen only in exceptional circumstances such as a special mode, for example, a verification mode and an evaluation mode is also included in the scope of the invention.

### Embodiment 3

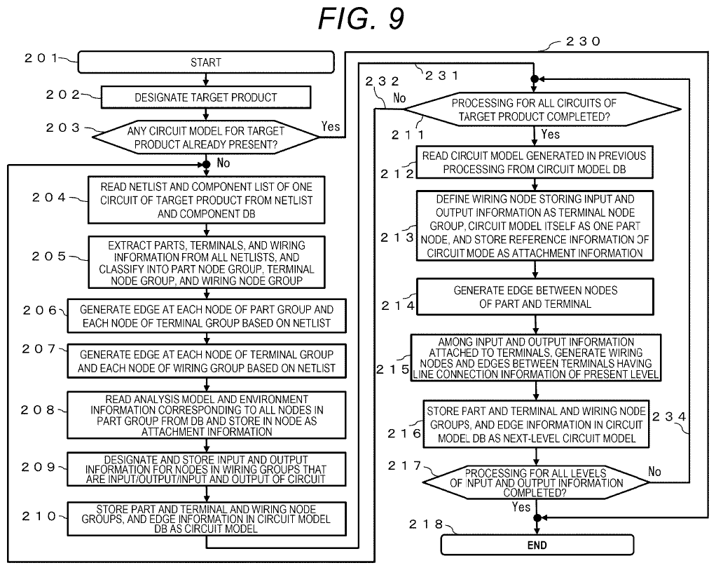

In the present embodiment, details of an example of processing in the circuit design support device 1 according to the present application will be described with reference to a flowchart. In particular, an example of processing of generating a circuit model data structure will be described with reference to FIG. 9.

The processing starts in 201. In 202, a target product is designated. In 203, it is determined whether a circuit model of the target product is already present. If YES, that is, if the circuit model is already present, the processing jumps to end at 218 through 230. If NO, that is, if the circuit model is not present, the processing proceeds to 204. In 204, a netlist and a component list of one circuit of the target product are read from the netlist and component DB. In 205, parts, terminals, and wiring information are extracted from all the netlists, and are classified into a part node group, a terminal node group, and a wiring node group. In 206, an edge is generated at each node of the part group and each node of the terminal group based on the netlist. In 207, an edge is generated at each node of the terminal group and each node of the wiring group based on the netlist. In 208, an analysis model and environment information corresponding to all the nodes in the part group are read from the DB and stored in the node as attachment information. In 209, input and output information is designated for nodes in the wiring groups that are input/output/input and output of the circuit and stored. In 210, the part and terminal and wiring node groups, and the edge information are stored in the circuit model DB as a circuit model at a next higher level. From 210, the flow continues to 211 through 231. In 211, it is determined whether the processing of all circuits of the target product is completed. If NO, that is, if the processing is not completed, the processing returns to 204 through 232, the netlist and the component list of the next circuit are read, and the processing is resumed. In the case of YES, the circuit model generated in the previous processing is read from the circuit model DB in 212. In 213, the wiring node storing the input and output information is defined as the terminal node group, the circuit model itself is defined as one part node, and reference information of the circuit model is stored as the attachment information. In 214, an edge is generated between nodes of the part and the terminal. In 215, among the input and output information attached to the terminals, the wiring nodes and the edges are generated between the terminals having line connection information of the present level. In 216, the part and terminal and wiring node groups, and the edge information are stored in the circuit model DB as a circuit model at a next higher level. In 218, it is determined whether the processing for all levels of the input and output information is completed. If NO, the processing returns to 211 through 234. If YES, the processing ends at 218.

The processing contents in the above flowchart will be described below.

The start of the flow is to designate a target product by a user. When the circuit model of the target product designated by the user is not generated, the circuit model data structure is generated in the flow.

First, the netlist and the component list of all the circuits mounted on the target product are read from the netlist and component DB to generate a circuit model data structure, and the analysis model, the environment information, and the input and output information are attached to each node.

Next, a circuit model to be used in a next higher level is generated based on the input and output information, and the generation processing is repeated until all the connections in all levels included in the input and output information are completed. Here, as an example of the configuration of input and output information, a level 1 is connected to a wiring X of the substrate A, a level 2 is connected to a wiring Y of a unit D, . . . , and a level N is connected to a wiring Z at the front of the device, and so on. By repeating the processing, an entire circuit model data structure is generated as an example.

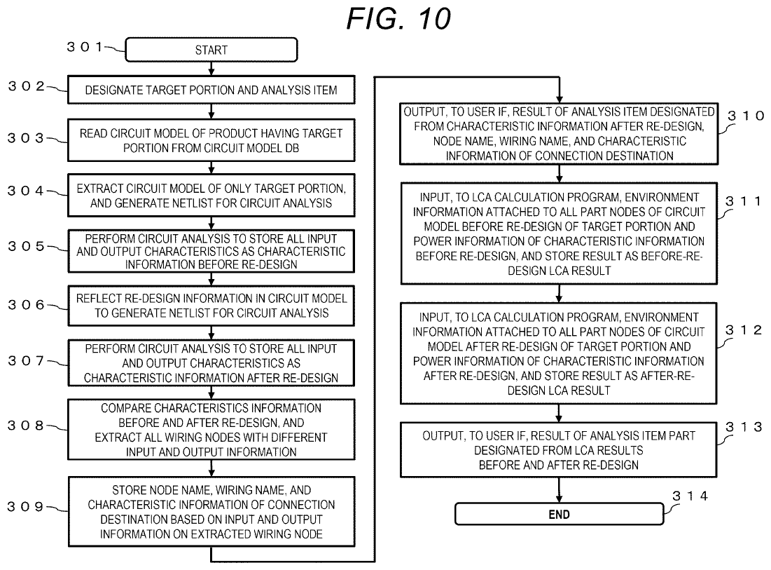

Next, an example of a performance and environment and influence range analysis flow will be described with reference to FIG. 10.

The processing starts in 301. In 302, a target portion and an analysis item are designated. In 303, a circuit model of the product having the target portion is read from the circuit model DB. In 304, a circuit model of only the target portion is extracted, and a netlist for circuit analysis is generated. In 305, circuit analysis is performed to store all input and output characteristics as characteristic information before re-design. In 306, re-design information is reflected in the circuit model to generate a netlist for the circuit analysis. In 307, the circuit analysis is performed to store all the input and output characteristics as characteristic information after re-design. In 308, the characteristics information before and after the re-design are compared with each other, and all of the wiring nodes with different input and output information are extracted. In 309, a node name, a wiring name, and the characteristic information of a connection destination are stored based on the input and output information on the extracted wiring node. In 310, a result of the analysis item designated from the characteristic information after the re-design, the node name, the wiring name, and the characteristic information of the connection destination are output to the user IF. In 311, the environment information attached to all the part nodes of the circuit model before the re-design of the target portion and power information of the characteristic information before the re-design are input to the LCA calculation program, and the result is stored as a before-re-design LCA result. In 312, the environment information attached to all the part nodes of the circuit model after the re-design of the target portion and the power information of the characteristic information after the re-design are input to the LCA calculation program, and the result is stored as an after-re-design LCA result. In 313, the result of the analysis item portion designated from the LCA results before the re-design and after the re-design is output to the user IF. The processing ends in 314.

The processing contents in the above flowchart will be described below.

The start of the flow is to designate the target portion and the analysis item by the user.

The circuit model of the product is read from the DB based on the target portion information designated by the user, and the circuit model of the target portion is extracted from the circuit model of the product. A netlist for analysis is generated based on the circuit model and subjected to the circuit analysis. Here, both the analysis results before the re-design and after the re-design are compared, and the connection destination of the wiring having the difference, the characteristic information thereof, and the designated analysis item are output to the user IF. The LCA is calculated based on the power information of the circuit analysis result and the environment information. In the LCA as well, both the designated items before and after the re-design are output to the user IF. The user checks the result of the designated analysis item and the influence range, and if necessary, sets the influenced portion as the target portion and the characteristic information as the analysis items and executes the present flow again.

The invention has been described with reference to a plurality of embodiments. Here, an example of the invention disclosed in the present specification will be described in another representation, for example.

### Aspect 1

In a circuit design support device including: a control unit including a calculation device; a memory; a storage; an input device; and a display device, the storage stores overall circuit information, the input device inputs changed circuit information in the overall circuit information to the control unit including the calculation device, and the control unit including the calculation device calculates an influence on performance of the changed circuit information and on performance of another circuit in the overall circuit information, and calculates an influence on environment performance due to the changed circuit information, and displays, on the display device, the calculated influence on the performance of the circuit information and influence on the performance of the another circuit in the overall circuit information, and the influence on the environment performance due to the changed circuit information.

### Aspect 2

In the circuit design support device according to Aspect 1, the environment performance is LCA performance.

### Aspect 3

In the circuit design support device according to Aspect 1, the control unit including the calculation device calculates the circuit information through modeling according to a graph topology to calculate the influence on the performance of the another circuit in the overall circuit information and the influence on the environment performance due to the changed circuit information.

### Aspect 4

In the circuit design support device according to Aspect 3, the modeling according to the graph topology includes a part node, a wiring node, and a terminal node located between the part node and the wiring node.

### Aspect 5

In the circuit design support device according to Aspect 4, the modeling according to the graph topology includes a part and terminal edge connecting the part node and the terminal node and a terminal and wiring edge connecting the terminal node and the wiring node.

### Aspect 6

A circuit design support device includes: a control unit including a calculation device; a memory; a storage; an input device; and a display device. The control unit including the calculation device, for circuit information to be subjected to a design change input from the input device, based on information from a database stored in the storage, calculates an influence on performance of a circuit to be subjected to the design change and an influence on performance of another circuit to which the circuit to be subjected to the design change is connected, and calculates an influence on environment performance due to the design change, and the control unit including the calculation device displays, on the display device, the influences on the performance of the circuit to be subjected to the design change and on the performance of the another circuit to which the circuit to be subjected to the design change is connected, and the influence on environment performance due to the design change.

### Aspect 7

In the circuit design support device according to Aspect 6, the environment performance is either power consumption or LCA performance.

### Aspect 8

In the circuit design support device according to Aspect 6, the control unit including the calculation device is allowed to display the circuit information on the display device in a graph topology.

### Aspect 9

In the circuit design support device according to Aspect 8, the graph topology includes a part node, a wiring node, and a terminal node located between the part node and the wiring node.

### Aspect 10

In the circuit design support device according to Aspect 9, the graph topology includes a part and terminal edge connecting the part node and the terminal node and a terminal and wiring edge connecting the terminal node and the wiring node.

### Aspect 11

A circuit design support device includes: a control unit including a calculation device; a memory; a storage; an input device; and a display device. The storage includes databases for a circuit netlist, a component list, environment information, an analysis model, and a circuit model, the circuit model is a graph data structure in which a node group is generated based on the netlist, which is a first set of parts, a second set of terminals, and a third set of wirings, and edges that are made up of connection information between the part and the terminal and connection information between the terminal and the wiring are generated, each node of a part node group, which is the first set, has a label that associates an analysis model of circuit performance corresponding to each part with environment load information, and each node of a wiring node group, which is the third set, has input and output terminal information indicating whether the node is input, output, or input and output of a product level, or other kind of indication, among the wiring node group, a wiring node associated with any of the input, the output, or the input and output is converted into a terminal node in an upper layer, and set as the terminal node in the upper layer, the circuit model itself is redefined as a single part node, an edge is generated between the part node and the wiring node, a wiring node in the upper layer is generated based on line connection information in a next higher level included in information of the input and output, and an edge is generated between the wiring node in the upper layer and the terminal node in the upper layer, thereby generating an upper level circuit model, the generation of the upper level circuit model is performed at all levels to generate the circuit model for the entire product, and for a circuit to be changed input from the input device to the control unit including the calculation device, another circuit portion which is more influenced by the change is determined, and performance and environment indexes of the circuit to be changed and the another circuit portion which is more influenced by the change are displayed on the display device.

The term “circuit design support device” in the present application also includes a circuit design support system.

Further, various modified examples and display modifications based on the ideas disclosed in the specification of the present application and the drawings are also included in the scope of the disclosure of the present application, as a matter of course, in the specification and the drawings of the application.

What is claimed is:

1. A circuit design support device comprising:
a control unit including a calculation device;
a memory; a storage;
an input device; and
a display device, wherein
the storage stores overall circuit information,
the input device inputs changed circuit information in the overall circuit information to the control unit including the calculation device, and
the control unit including the calculation device
calculates an influence on performance of the changed circuit information and on performance of another circuit in the overall circuit information, and calculates an influence on environment performance due to the changed circuit information, and
displays, on the display device, the calculated influence on the performance of the circuit information and influence on the performance of the another circuit in the overall circuit information, and the influence on the environment performance due to the changed circuit information.

2. The circuit design support device according to claim 1, wherein
the environment performance is LCA performance.

3. The circuit design support device according to claim 1, wherein
the control unit including the calculation device calculates the circuit information through modeling according to a graph topology to calculate the influence on the performance of the another circuit in the overall circuit information and the influence on the environment performance due to the changed circuit information.

4. The circuit design support device according to claim 3, wherein
the modeling according to the graph topology includes a part node, a wiring node, and a terminal node located between the part node and the wiring node.

5. The circuit design support device according to claim 4, wherein
the modeling according to the graph topology includes a part and terminal edge connecting the part node and the terminal node and a terminal and wiring edge connecting the terminal node and the wiring node.

6. A circuit design support device comprising:
a control unit including a calculation device;
a memory;
a storage;
an input device; and
a display device, wherein
the control unit including the calculation device, for circuit information to be subjected to a design change input from the input device, based on information from a database stored in the storage, calculates an influence on performance of a circuit to be subjected to the design change and an influence on performance of another circuit to which the circuit to be subjected to the design change is connected, and calculates an influence on environment performance due to the design change, and
the control unit including the calculation device displays, on the display device, the influences on the performance of the circuit to be subjected to the design change and on the performance of the another circuit to which the circuit to be subjected to the design change is connected, and the influence on environment performance due to the design change.

7. The circuit design support device according to claim 6, wherein
the environment performance is either power consumption or LCA performance.

8. The circuit design support device according to claim 6, wherein
the control unit including the calculation device is allowed to display the circuit information on the display device in a graph topology.

9. The circuit design support device according to claim 8, wherein
the graph topology includes a part node, a wiring node, and a terminal node located between the part node and the wiring node.

10. The circuit design support device according to claim 9, wherein
the graph topology includes a part and terminal edge connecting the part node and the terminal node and a terminal and wiring edge connecting the terminal node and the wiring node.

11. A circuit design support device comprising:
a control unit including a calculation device;
a memory;
a storage;
an input device; and
a display device, wherein
the storage includes databases for a circuit netlist, a component list, environment information, an analysis model, and a circuit model,
the circuit model is a graph data structure in which a node group is generated based on the netlist, which is a first set of parts, a second set of terminals, and a third set of wirings, and edges that are made up of connection information between the part and the terminal and connection information between the terminal and the wiring are generated, each node of a part node group, which is the first set, has a label that associates an analysis model of circuit performance corresponding to each part with environment load information, and each node of a wiring node group, which is the third set, has input and output terminal information indicating whether the node is input, output, or input and output of a product level, or other kind of indication,
among the wiring node group, a wiring node associated with any of the input, the output, or the input and output is converted into a terminal node in an upper layer, and set as the terminal node in the upper layer, the circuit model itself is redefined as a single part node, an edge is generated between the part node and the wiring node, a wiring node in the upper layer is generated based on line connection information in a next higher level included in information of the input and output, and an edge is generated between the wiring node in the upper layer and the terminal node in the upper layer, thereby generating an upper level circuit model,
the generation of the upper level circuit model is performed at all levels to generate the circuit model for the entire product, and
for a circuit to be changed input from the input device to the control unit including the calculation device, another portion which is more influenced by the change is determined, and performance and environment indexes of the circuit to be changed and the another circuit portion which is more influenced by the change are displayed on the display device.
